(19) United States
(12) Patent Application Publication
(10) Pub. No.: US 2014/0136825 A1
(43) Pub. Date: May 15, 2014

(54) PARAMETER SETTING SUPPORT DEVICE, AND PARAMETER SETTING SUPPORT METHOD

(71) Applicant: FUJITSU LIMITED, Kawasaki-shi (JP)

(72) Inventors: Tetsuya UCHIUMI, Kawasaki (JP); YASUHIDE MATSUMOTO, Kawasaki (JP); Shinji KIKUCHI, Yokohama (JP); Shinya KITAJIMA, Inagi (JP)

(73) Assignee: FUJITSU LIMITED, Kawasaki-shi (JP)

(21) Appl. No.: 13/971,948

(22) Filed: Aug. 21, 2013

(30) Foreign Application Priority Data
Nov. 14, 2012 (JP) 2012-250622

(51) Int. Cl. G06F 9/44

(52) U.S. Cl. CPC G06F 9/4401
USPC 713/1

(57) ABSTRACT

In a parameter setting support device, a storage unit stores, for each design target that has been previously designed, related information on a plurality of devices included in a design target and information on a setting of a parameter that has been used for designing, and a design-rule generating unit generates, by using the related information stored in the storage unit, multiple rules with respect to a parameter that is common to the design targets, the rules indicating the conditions and definitions that are used for a setting of the parameter, and a design-procedure generating unit generates a procedure to execute the rules in accordance with the manually input value of a parameter and the generated rules.

### CROSS-REFERENCE TO RELATED APPLICATION

This application is based upon and claims the benefit of priority of the prior Japanese Patent Application No. 2012-250622 filed on Nov. 14, 2012, the entire contents of which are incorporated herein by reference.

### FIELD

The embodiment discussed herein is directed to a parameter setting support program, a parameter setting support device, and a parameter setting support method.

### BACKGROUND

In recent years, cloud systems have been utilized in which the server or network virtualization technology is used so that multiple computing resources on a network can be used as the user's computing resource. Such a cloud system has become bigger and more complicated, and its system is changed on a daily basis. For example, devices are additionally installed, new parameters associated with the system design are added, and the design principles are changed.

The system is designed in response to the request for the system change. For the system design, the designer creates the design rules and design procedure. Here, the design rule refers to the rule for setting the parameter related to the designing, and the design procedure is obtained by arranging the design rules in the order they are executed. In accordance with the created design rule and design procedure, a parameter related to the system to be changed is generated by a device that automatically generates parameters.

Furthermore, there is a technology for automatically configuring the system in response to the request for the system change. By way of example, when a server configuration support device receives a system requirement, the server configuration support device applies it to the variable defined by the skeleton information on the system configuration parameter used for configuring each application program, thereby generating the system configuration parameter for each server. The server configuration support device delivers and applies the generated system configuration parameter to a target server, thereby achieving the system configuration. The skeleton information on the system configuration parameter used by the server configuration support device is manually created in advance.

By way of another example, there is a known technology for achieving the system configuration on the basis of the item definition information that contains items defined corresponding to the pattern of the configuration system and the configuration flow definition information that defines, corresponding to the pattern, the process to input the value to an item and the order of processes. With this technology, on the basis of the item definition information and the configuration flow corresponding to the pattern of the designated system, the system configuration device receives an input of the value for the item corresponding to the process and, after the item is set, generates system definition information and configuration script for setting the environment of a configuration target server of the system. The system configuration device delivers an agent program that executes the configuration script to the system configuration target server and causes it to execute the configuration script. The item definition information and the configuration flow definition information used by the system configuration device are manually created in advance.

Patent Literature 1: Japanese Laid-open Patent Publication No. 2006-72772

Patent Literature 2: Japanese Laid-open Patent Publication No. 2010-55499

However, a large-scale system, such as a cloud system, has a problem in that it is difficult to manually design the system. Specifically, in such a system, the system is changed on a daily basis, the relationship between parameters is complicated, and the design principle depends on the system to be designed. Therefore, it is difficult for a designer to create design rules and design procedures for the system design each time the system is changed.

Even with the technology for automatically configuring the system, it is difficult for a designer to create the skeleton information on a system configuration parameter for a large-scale system. Furthermore, it is also difficult for a designer to create the item definition information and the configuration flow definition information. Therefore, in the case of a large-scale system, it is difficult to manually design the system.

### SUMMARY

According to an aspect of an embodiment, a non-transitory computer-readable recording medium stores a parameter setting support program. The parameter setting support program causes a computer to execute a process. The process includes storing in a storage unit, for each design target that has been previously designed, related information on a plurality of devices included in a design target and information on a setting of a parameter that has been used for designing. The process includes generating, by using the related information stored in the storage unit, multiple rules with respect to a parameter that is common to the design targets, the rules indicating conditions and definitions that are used for a setting of the parameter. The process includes generating a procedure to execute the rules in accordance with a manually input value of a parameter and the generated rules.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a function block diagram that illustrates the configuration of a parameter setting support device according to an embodiment;

FIG. 2 is a diagram that illustrates an example of the data structure of teaching data;

FIG. 3 is a diagram that illustrates the common-part identifying method performed by a clustering unit;

FIG. 4A is a diagram (1) that illustrates the manually input parameter determination method performed by a parameter determining unit;

FIG. 4B is a diagram (2) that illustrates the manually input parameter determination method performed by the parameter determining unit;

FIG. 5A is a diagram (1) that illustrate the operation performed by a design-procedure generating unit;

FIG. 5B is a diagram (2) that illustrate the operation performed by the design-procedure generating unit;

FIG. 6 is a diagram that illustrates the recursive clustering algorithm processing;

FIG. 7 is a diagram that illustrates the specific example of the teaching data;

FIG. 8A is a diagram (1) that illustrates the specific example of the operation performed by the clustering unit;

FIG. 8B is a diagram (2) that illustrate the specific example of the operation performed by the clustering unit;

FIG. 9A is a diagram (1) that illustrates the specific example of the operation performed by the parameter determining unit;

FIG. 9B is a diagram (2) that illustrates the specific example of the operation performed by the parameter determining unit;

FIG. 10A is a diagram (1) that illustrates the specific example of the operation performed by the design-procedure generating unit;

FIG. 10B is a diagram (2) that illustrates the specific example of the operation performed by the design-procedure generating unit;

FIG. 10C is a diagram (3) that illustrates the specific example of the operation performed by the design-procedure generating unit;

FIG. 10D is a diagram (4) that illustrates the specific example of the operation performed by the design-procedure generating unit;

FIG. 11 is a diagram that illustrates the specific example of the operation performed by the parameter generating unit when a new data center is added;

FIG. 12A is a diagram (1) that illustrates the specific example of the operation performed by the parameter generating unit when a server is added;

FIG. 12B is a diagram (2) that illustrates the specific example of the operation performed by the parameter generating unit when a server is added;

FIG. 13A is a diagram (1) that illustrates the specific example of the operation performed by the parameter generating unit when the design principle is changed;

FIG. 13B is a diagram (2) that illustrates the specific example of the operation performed by the parameter generating unit when the design principle is changed;

FIG. 14 is a diagram that illustrates the specific example of the operation performed by the parameter generating unit when a new parameter is added;

FIG. 15 is a flowchart that illustrates the steps of the operation performed by the design-rule generating unit;

FIG. 16 is a flowchart that illustrates the steps of the operation performed by the design-procedure generating unit;

FIG. 17 is a flowchart that illustrates the steps of the operation by the recursive clustering algorithm;

FIG. 18 is a flowchart that illustrates the steps of the operation performed by the parameter generating unit;

FIG. 19 is a flowchart that illustrates the steps of the operation for a termination check; and

FIG. 20 is a diagram that illustrates an example of a computer that performs a parameter setting support program.

### DESCRIPTION OF EMBODIMENTS

Preferred embodiments of the present invention will be explained with reference to accompanying drawings The present invention is not limited to the embodiment.

Configuration of Parameter Setting Support Device

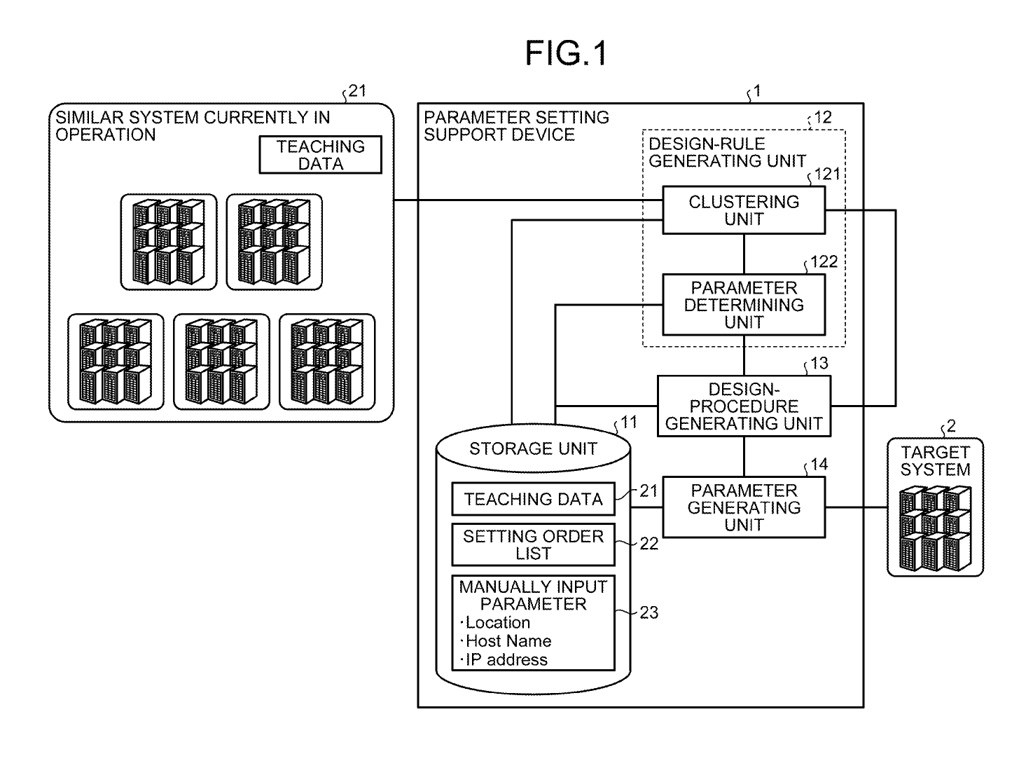

FIG. 1 is a functional block diagram that illustrates the configuration of a parameter setting support device according to an embodiment. A parameter setting support device 1 supports the settings of the parameters that are used for the system design. For example, when a new system is added to the cloud system, the parameter setting support device 1 sets the parameters in the system (referred to as the “target system”). The parameter setting support device 1 generates a design rule and a design procedure used for the parameter settings by using, for example, the parameter setting information (teaching data 21) of a similar system that is operating in the cloud system. Here, the design rule is the rule for setting the parameters related to the system design, and it includes its condition and definition. The design procedure is obtained by arranging the design rules in the order that they are executed. The parameter setting support device 1 generates and sets the parameters to the target system 2 in accordance with the generated design rule and design procedure.

As illustrated in FIG. 1, the parameter setting support device 1 includes a storage unit 11, a design-rule generating unit 12, a design-procedure generating unit 13, and a parameter generating unit 14.

The storage unit 11 corresponds to a storage device, such as a non-volatile semiconductor memory device, for example, flash memory or ferroelectric random access memory (FRAM) (registered trademark). The storage unit 11 includes the teaching data 21, a setting order list 22, and manually input parameters 23. The teaching data 21 is the parameter setting information of a similar system that has the similar configuration to that of the target system 2. The teaching data 21 is stored in the storage unit 11 by a clustering unit 121 that will be explained later. An example of the data structure of the teaching data 21 will be explained later. The setting order list 22 is the list that indicates the order in which the parameters are set and the order in which the design rules are executed, and it corresponds to the design procedure. The setting order list 22 is stored in the storage unit 11 by the design-procedure generating unit 13 that will be explained later. The manually input parameter 23 is a parameter whose value is set by a manual input. The manually input parameter 23 is stored in the storage unit 11 by a parameter determining unit 122 and the design-procedure generating unit 13 that will be explained later.

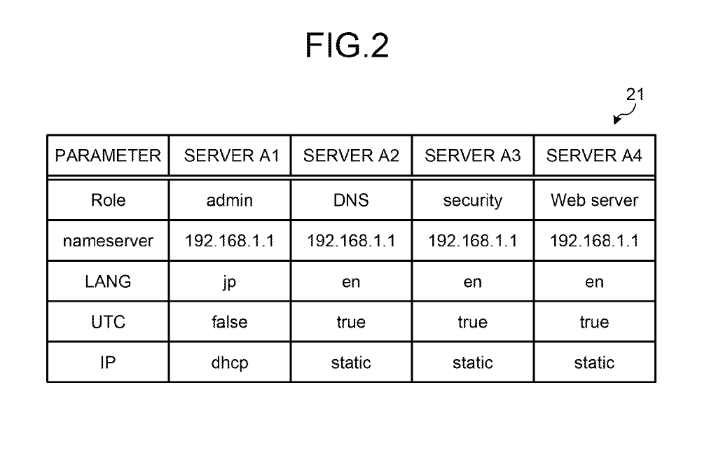

Here, an explanation is given, with reference to FIG. 2, of an example of the data structure of the teaching data 21 of a similar system. FIG. 2 is a diagram that illustrates an example of the data structure of the teaching data. As illustrated in FIG. 2, the teaching data 21 is stored such that the parameters, a server A1, a server A2, a server A3, and a server A4 are related to one another.

The server A1, the server A2, the server A3, and the server A4 are the names of the servers installed in the similar system. Here, the four servers are installed; however, there is no limitation on this example. Five servers or three servers may be installed. Any number of servers may be provided if they are installed in the similar system.

The parameters are used for the system design. Here, the parameters include “Role”, “nameserver”, “LANG”, “UTC”, and “IP”. The “Role” indicates the role of a server. The “nameserver” indicates the IP address of Domain Name Service (DNS). The “LANG” indicates the language used by a server. The “UTC” indicates whether the universal time coordinated is to be used. For example, if “true”, it means that the universal time coordinated is to be used and, if “false”, it means that the universal time coordinated is not to be used. The “IP” indicates whether the assignment of an IP address is dynamic or static. For example, if “dhcp”, it means that it is dynamic and, if “static”, it means that it is static.

The values of the above parameters are set for each of the servers. For example, in the case of the server A1, “admin” is set to the parameter “Role”, and “192.168.1.1” is set to the parameter “nameserver”. Furthermore, “jp” is set to the parameter “LANG”, “false” is set to the parameter “UTC”, and “dhcp” is set to the parameter “IP”.

With reference back to FIG. 1, the design-rule generating unit 12 generates a design rule that is used for the parameter settings. The design-rule generating unit 12 includes the clustering unit 121 and the parameter determining unit 122.

The clustering unit 121 generates multiple design rules by using the teaching data 21. A design rule generated is synonymous with a “cluster”, which will be used below. For example, the clustering unit 121 uses a clustering technique so as to identify, from the teaching data 21, the common part on the basis of a design unit. The clustering unit 121 then generates a design rule from the clustering result. Here, a design unit refers to, for example, a data center as a unit, a location as a unit, or a server as a unit. Any clustering technique may be used as the above clustering technique.

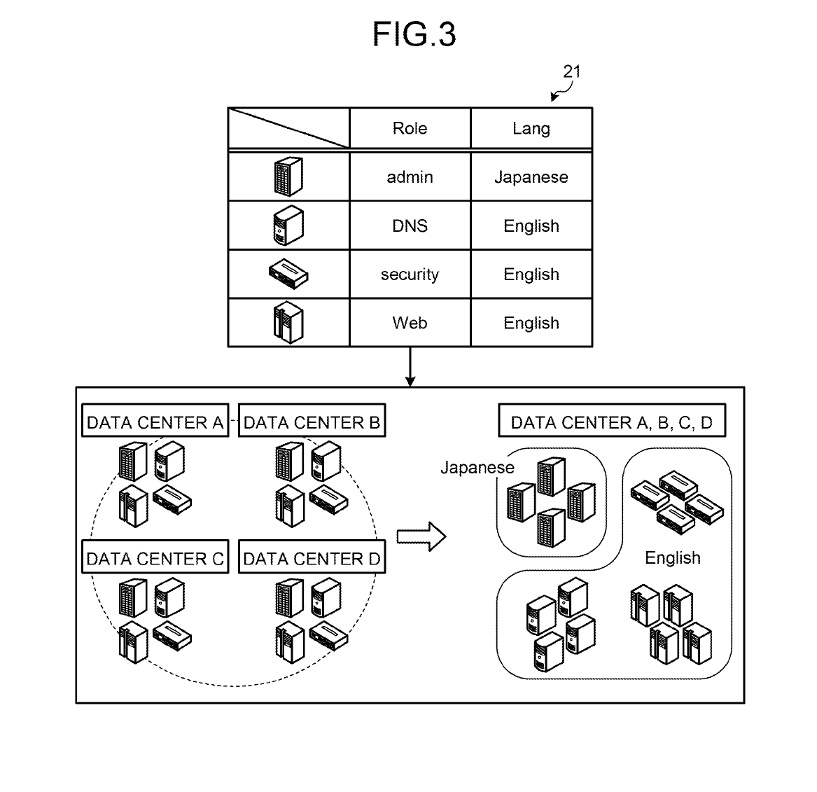

Here, an explanation is given, with reference to FIG. 3, of the common-part identifying method performed by the clustering unit 121 in the case where a design unit is a data center as a unit. FIG. 3 is a diagram that illustrates the common-part identifying method performed by the clustering unit.

In the teaching data 21 of each of the data centers A, B, C, and D, as illustrated in the upper section of FIG. 3, the same values are set to each server with respect to the parameters “Role” and “Lang”. The clustering unit 121 uses the clustering technique so as to identify the common part from the teaching data 21. Here, as illustrated in the lower section of FIG. 3, in the data centers A, B, C, and D, the part of servers for which the value “Japanese” is set to the parameter “Lang” is the common part, and the part of servers for which the value “English” is set to the parameter “Lang” is the common part.

The clustering unit 121 then generates design rules from the clustering result. Here, a design rule is generated such that, if the parameter “Role” is “admin”, the parameter “Lang” is set to “Japanese”. Furthermore, a design rule is generated such that, if the parameter “Role” is other than “admin”, the parameter “Lang” is set to “English”. Specifically, the design rules (clusters) generated by the clustering unit 121 are represented by the following <1> and <2>.

IF Role=”admin” THEN LANG=Japanese...
<1>
IF Role!=”admin” THEN LANG=English...
<2>

A design rule includes its condition and definition. For example, as for <1>, the condition of the design rule is “IF Role=“admin””, and the definition of the design rule is “THEN LANG=Japanese”.

With reference back to FIG. 1, the parameter determining unit 122 determines a manually input parameter among the parameters included in the teaching data 21. For example, the parameter determining unit 122 determines that the parameter that has a unique value with respect to all the servers within each design unit is a manually input parameter. This is because, if the parameter has a unique value with respect to all the servers, it is difficult for the parameter determining unit 122 to set the value of the parameter by using the condition and the definition. Furthermore, the parameter determining unit 122 determines that the parameter that has a unique value among the design units, i.e., the parameter that has a unique value in each design unit is a manually input parameter. This is because, if the parameter has a unique value among the design units, it is difficult for the parameter determining unit 122 to set the value of the parameter by using the condition and the definition. The parameter determining unit 122 stores the determined manually input parameter as the manually input parameter 23 in the storage unit 11.

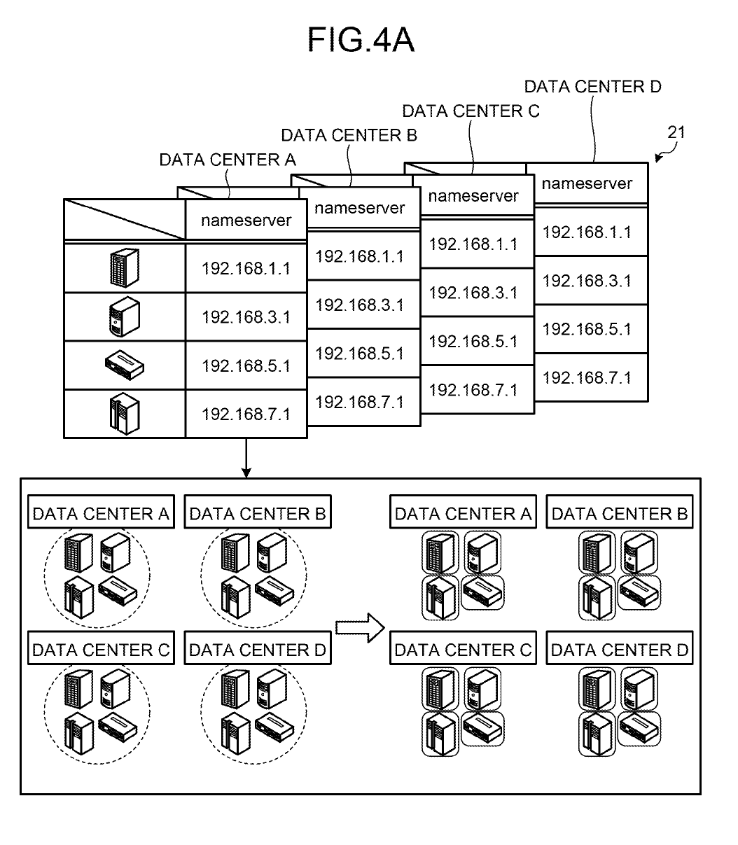

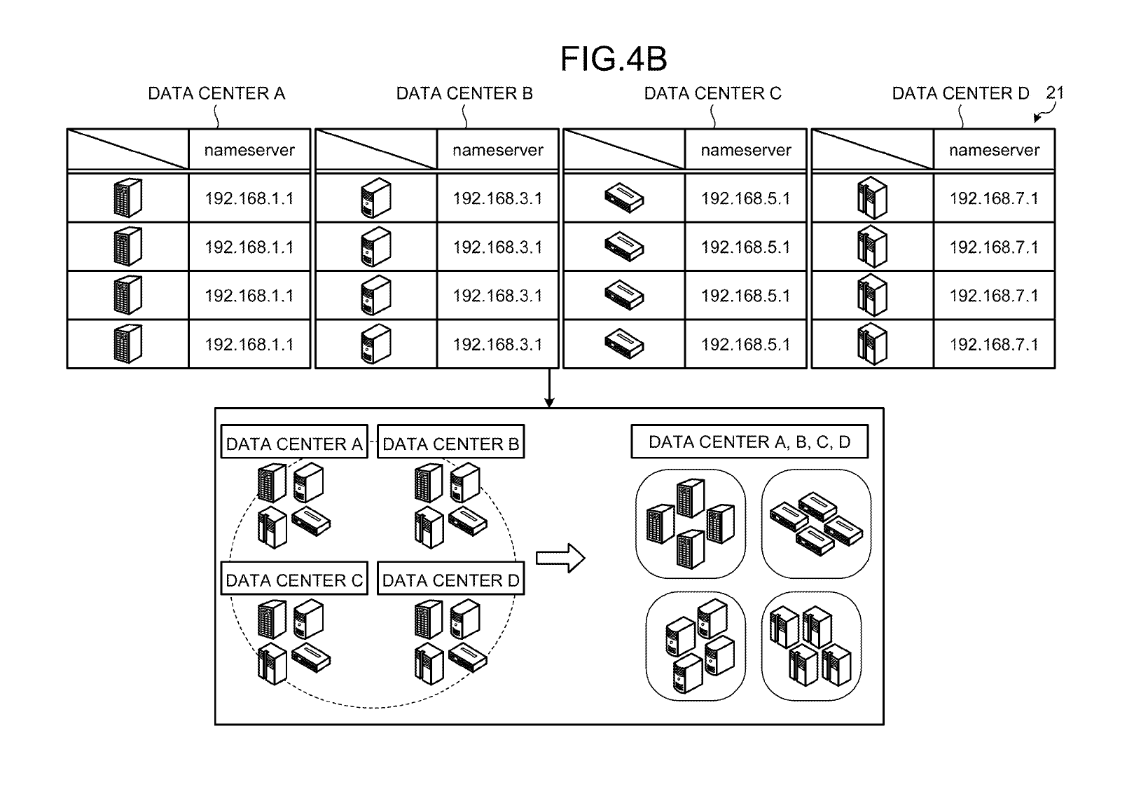

Here, an explanation is given, with reference to FIGS. 4A and 4B, of the manually input parameter determination method performed by the parameter determining unit 122 in the case where a design unit is a data center as a unit. FIGS. 4A and 4B are diagrams that illustrate the manually input parameter determination method performed by the parameter determining unit.

In the teaching data 21 of each of the data centers A, B, C, and D, as illustrated in the upper and lower sections of FIG. 4A, the value of the parameter “nameserver” corresponding to each server is a unique value within each of the data centers A, B, C, and D. The parameter determining unit 122 determines that the parameter that has a unique value with respect to all the servers within each of the data centers is a manually input parameter. Here, the parameter determining unit 122 determines that the parameter “nameserver” that has a unique value within each of the data centers A, B, C, and D is a manually input parameter.

In the teaching data 21 of each of the data centers A, B, C, and D, as illustrated in the upper and lower sections of FIG. 4B, the value of the parameter “nameserver” corresponding to each server is a unique value among the data centers A, B, C, and D. The parameter determining unit 122 determines that the parameter that has a unique value among the data centers, i.e., the parameter that has a unique value in each of the data centers is a manually input parameter. Here, the parameter determining unit 122 determines that the parameter “nameserver” that has a unique value among the data centers is a manually input parameter.

With reference back to FIG. 1, the design-procedure generating unit 13 generates a design procedure in accordance with the design rule generated by the clustering unit 121 for each parameter and in accordance with the manually input parameter determined by the parameter determining unit 122. For example, the design-procedure generating unit 13 identifies the design rule whose condition is satisfied by the value of the manually input parameter. The design-procedure generating unit 13 then adds the identified design rule to the setting order list 22 as the design procedure. Furthermore, the design-procedure generating unit 13 identifies the design rule whose condition is satisfied by the manual input and the definition of the identified design rule and then adds the identified design rule to the setting order list 22 as the design procedure. Thus, the design-procedure generating unit 13 repeatedly identifies the design rule whose condition is satisfied by the manual input and the definition of the identified design rule and adds the identified design rule to the setting order list 22, thereby generating the design procedure.

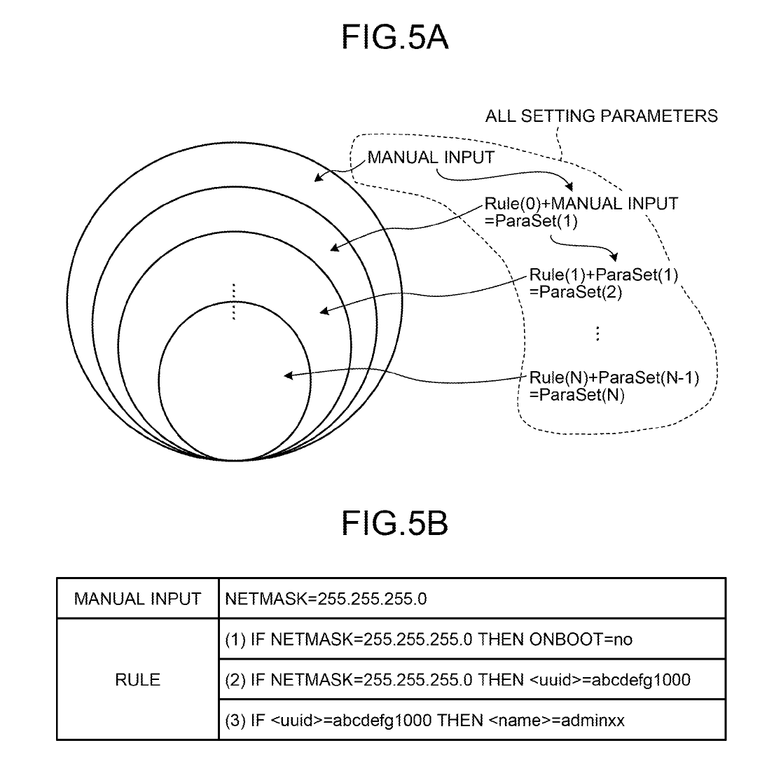

Here, an explanation is given, with reference to FIGS. 5A and 5B, of the operation performed by the design-procedure generating unit 13 to generate a design procedure. FIGS. 5A and 5B are diagrams that illustrate the operation performed by the design-procedure generating unit.

As illustrated in FIG. 5A, the design-procedure generating unit 13 identifies the design rule “Rule (0)” whose condition is satisfied by the manual input. The design rule “Rule (0)” is added to the setting order list 22 as the first design procedure. The design-procedure generating unit 13 then uses the definition “ParaSet (1)” of the design rule “Rule (0)” so as to identify the design rule “Rule (1)” whose condition is subsequently satisfied. The design rule “Rule (1)” is added to the setting order list 22 as the second design procedure. Thus, the design-procedure generating unit 13 recursively identifies the design rules in order, starting from the manual input, thereby setting the design procedure.

As illustrated in FIG. 5B, the value “255.255.255.0” is set to the manually input parameter “NETMASK” by the manual input. The design-procedure generating unit 13 identifies the design rules (1) and (2) because the conditions of the design rules (1) and (2) are satisfied by the information on “NETMASK” that is set by the manual input. The design rules (1) and (2) are added to the setting order list 22. The design-procedure generating unit 13 then identifies the design rule (3) because the condition of the design rule (3) is satisfied by the information “<uuid>=abcdefg1000” that is the definition of the design rule (2). The design rule (3) is added to the setting order list 22. Thus, the design procedure of the design rules illustrated in FIG. 5B is in the following order: (1)→(2)→(3). The design procedure of the design rules illustrated in FIG. 5B may be in the following order: (2)→(1)→(3).

With reference back to FIG. 1, the design-procedure generating unit 13 performs the following operation if there is a design rule whose condition is not satisfied by the manual input and the definition of the identified design rule. The design-procedure generating unit 13 extracts a set of design rules whose conditions are to be satisfied by one more. The design-procedure generating unit 13 then detects any two design rules from the set of design rules, the definitions of the design rules being included in each other's condition. The term “circular reference” is used if the definitions of the two design rules are included in each other's condition, i.e., if the definitions of the two design rules can refer to each other's condition. The design-procedure generating unit 13 eliminates, from the teaching data 21, any one of the parameters that are defined by the two design rules between which a circular reference is formed. The design-procedure generating unit 13 then causes the clustering unit 121 to perform the clustering operation again on the other one of the parameters by using the parameters except for the eliminated parameter. Thus, after the clustering operation is performed again, the design-procedure generating unit 13 can generate a design rule that is not related to the parameter with which a circular reference is formed.

After the clustering operation has been performed again, the design-procedure generating unit 13 identifies the design rule whose condition is satisfied by the value of the manually input parameter and the definition of the previously identified design rule. If the design rule has been identified, the design-procedure generating unit 13 adds the design rule to the setting order list 22 as the design procedure. Conversely, if the design rule has not been identified, the design-procedure generating unit 13 determines that the parameter included in the definition of the design rule that has not been identified is a manually input parameter and stores it as the manually input parameter 23 in the storage unit 11. As described above, the process to generate a design procedure by recursively performing the clustering operation is referred to as the “recursive clustering algorithm”.

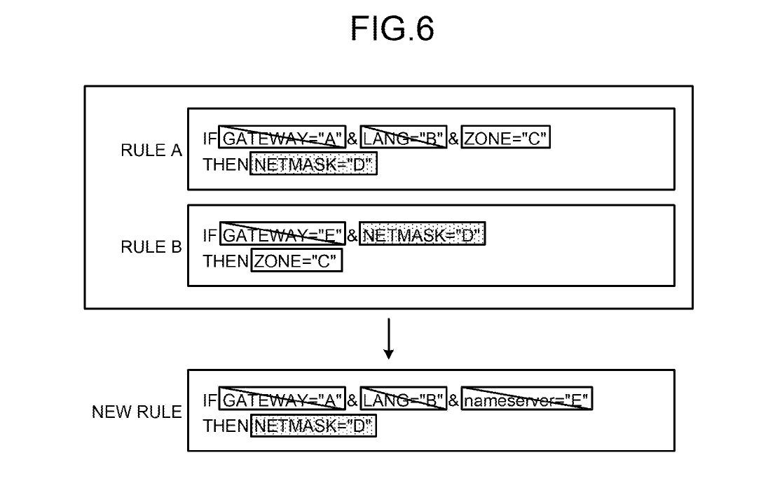

Here, an explanation is given, with reference to FIG. 6, of recursive clustering algorithm processing. FIG. 6 is a diagram that illustrates the recursive clustering algorithm processing.

As illustrated in the upper section of FIG. 6, the design rule A and the design rule B are circular-reference design rules. Specifically, the definition “NETMASK=“D”” of the design rule A is included in the condition of the design rule B, and the definition “ZONE=“C”” of the design rule B is included in the condition of the design rule A. The design-procedure generating unit 13 detects the circular-reference design rules A and B. The design-procedure generating unit 13 then temporarily eliminates, from the teaching data 21, one of the parameters between which a circular reference is formed. Here, the design-procedure generating unit 13 eliminates the parameter “ZONE” that is one of the parameters between which a circular reference is formed. The design-procedure generating unit 13 then causes the clustering unit 121 to perform the clustering operation again on the other one of the parameter, “NETMASK”. Thus, a design rule is generated which is not related to the parameter “ZONE” with which a circular reference is formed.

As illustrated in the lower section of FIG. 6, a new design rule is generated by the clustering unit 121 with respect to the parameter “NETMASK”. The design-procedure generating unit 13 then identifies the design rule whose condition is satisfied by the manual input and the definition of the previously identified design rule. Here, because the condition of the new design rule is satisfied, the design-procedure generating unit 13 identifies the new design rule. The design-procedure generating unit 13 then adds the new design rule to the setting order list 22 as the design procedure.

With reference back to FIG. 1, in accordance with the design procedure generated by the design-procedure generating unit 13, the parameter generating unit 14 generates information on the parameters that are used for designing the target system 2 that is a new design target. The parameter generating unit 14 then sets the generated parameter information to the target system 2. For example, when the parameter generating unit 14 receives a manual input with respect to the parameter stored as the manually input parameter 23, the parameter generating unit 14 generates information on the manually input parameter by using the received input data. The parameter generating unit 14 then sequentially generates information on the parameter in accordance with the setting procedure stored in the setting order list 22. Here, if there are areas that have not been generated, the parameter generating unit 14 requests the administrator to make a manual input for the area corresponding to the parameter that comes first in the order among the areas that have not been generated. The case where there are areas that have not been generated is, for example, the case where a new server is added to the target system 2. Another example is a case where a new parameter to be set is added to the target system 2. Further, another example is the case where the design principle of the target system 2 is changed. The parameter generating unit 14 then sets the generated parameter to the target system 2.

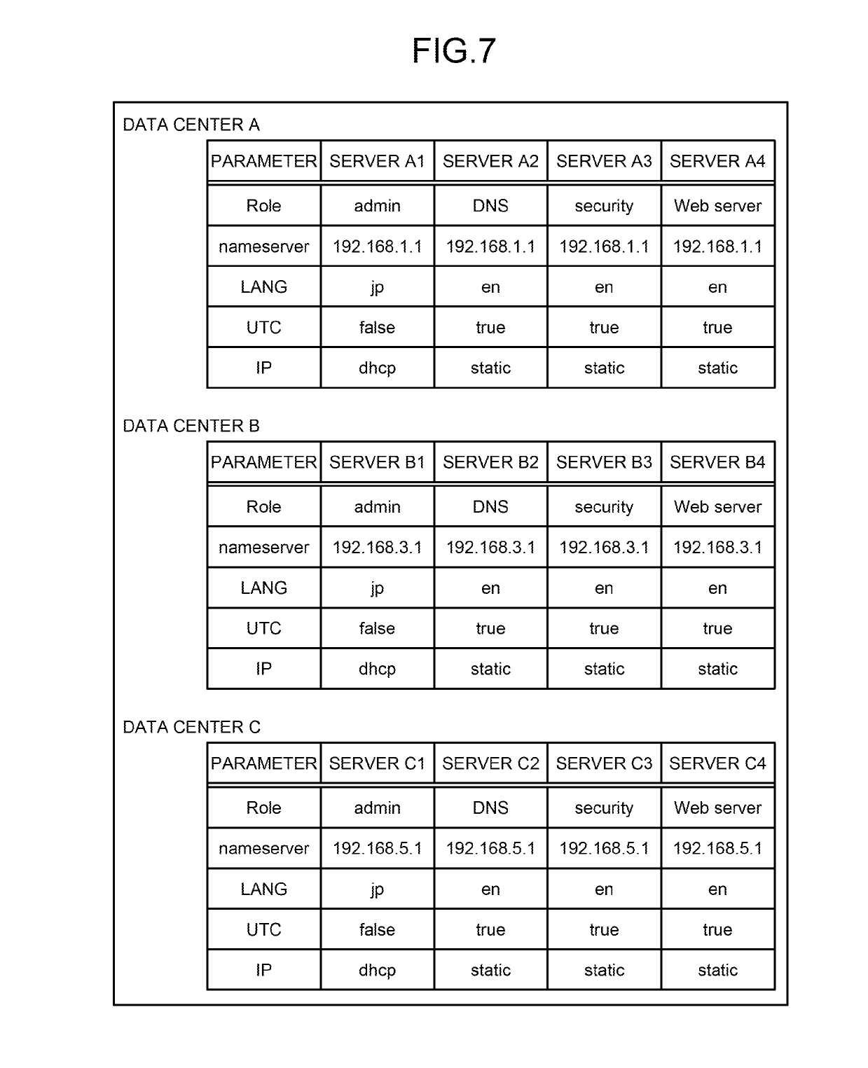

Next, an explanation is given, with reference to FIGS. 7 to 14, of the specific example of a parameter setting support process in the case where a design unit is a data center as a unit. FIG. 7 is a diagram that illustrates the specific example of the teaching data. As illustrated in FIG. 7, in the teaching data 21, corresponding values are set to various parameters for each of the servers installed in the data centers A, B, C, and D.

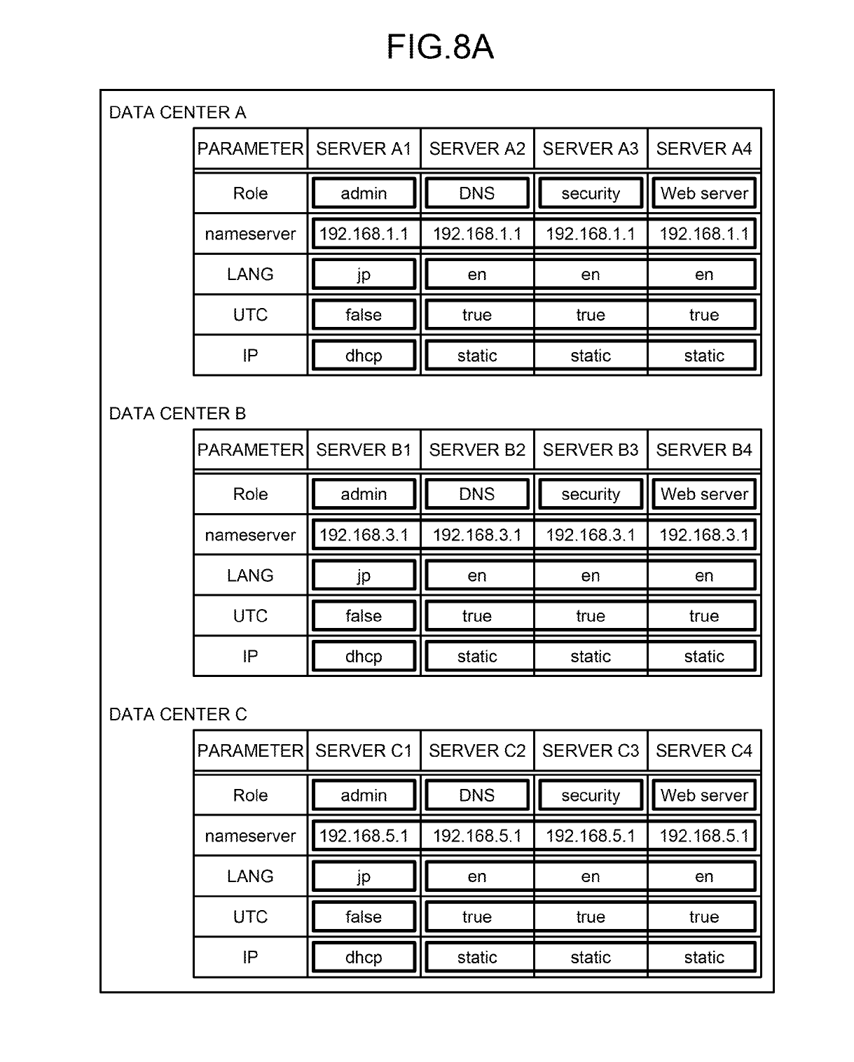

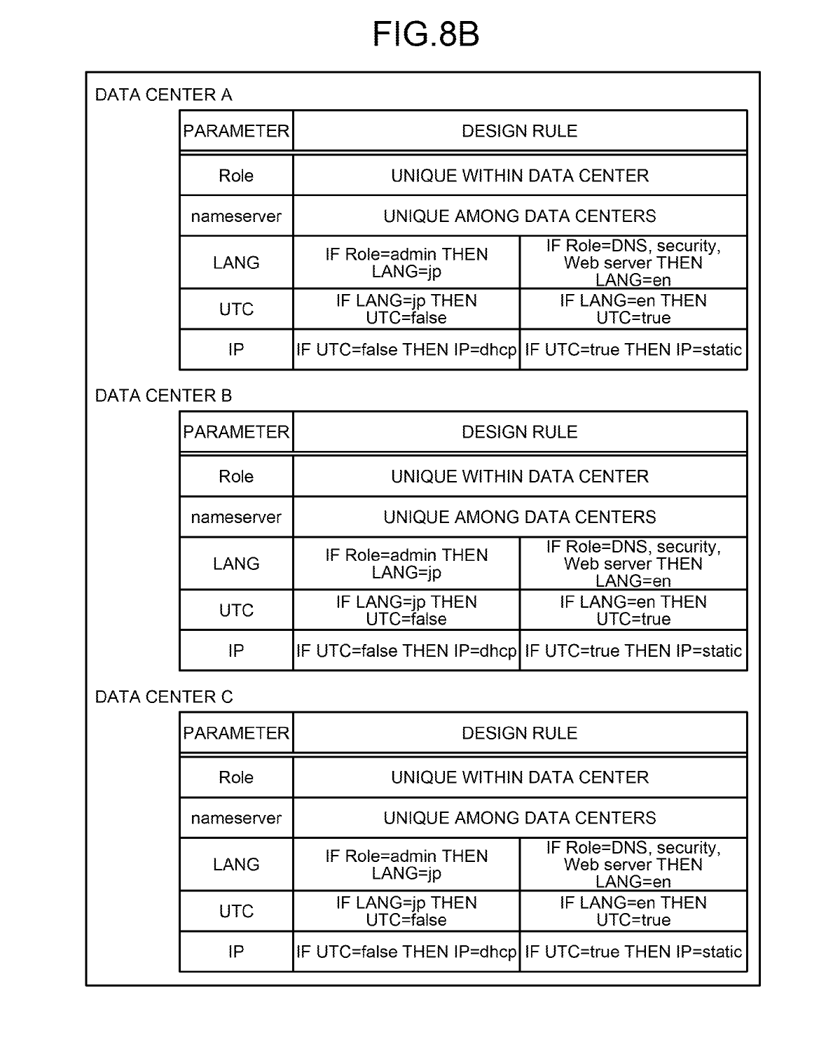

FIGS. 8A and 8B are diagrams that illustrate the specific example of the operation performed by the clustering unit. As illustrated in FIG. 8A, the clustering unit 121 uses the clustering technique so as to identify, from the teaching data 21, the common part of the data centers, which are design units. Here, it is difficult for the clustering unit 121 to identify the common part because the unique values, such as “admin”, “DNS”, “security”, and “Web server” are set to the parameter “Role” in the data centers A, B, and C. Furthermore, “192.168.1.1” is set to the parameter “nameserver” with respect to all the servers in the data center A, “192.168.3.1” with respect to all the servers in the data center B, and “192.168.5.1” with respect to all the servers in the data center C. Thus, as the unique value is set in each of the data centers, it is difficult for the clustering unit 121 to identify the common part. The clustering unit 121 identifies, as the common part, the part of servers for which the value “jp” is set to the parameter “LANG” and the part of servers for which the value “en” is set to the parameter “LANG”. Furthermore, the clustering unit 121 identifies, as the common part, the part of servers for which the value “false” is set to the parameter “UTC” and the part of servers for which the value “true” is set to the parameter “UTC”. Moreover, the clustering unit 121 identifies, as the common part, the part of servers for which the value “dhcp” is set to the parameter “IP” and the part of servers for which the value “static” is set to the parameter “IP”.

As illustrated in FIG. 8B, the clustering unit 121 generates a design rule from the clustering result. Here, the clustering unit 121 generates the design rule “unique within a data center” with regard to the parameter “Role”. Furthermore, the clustering unit 121 generates the design rule “unique among data centers” with regard to the parameter “nameserver”. Moreover, the clustering unit 121 generates the design rule “IF Role=admin THEN LANG=jp”, “IF Role=DNS, security, Web server THEN LANG=en” with regard to the parameter “LANG”. Further, the clustering unit 121 generates the design rule “IF LANG=jp THEN UTC=false”, “IF LANG=en THEN UTC=true” with regard to the parameter “UTC”. Moreover, the clustering unit 121 generates the design rule “IF UTC=false THEN IP=dhcp”, “IF UTC=true THEN IP=static” with regard to the parameter “IP”.

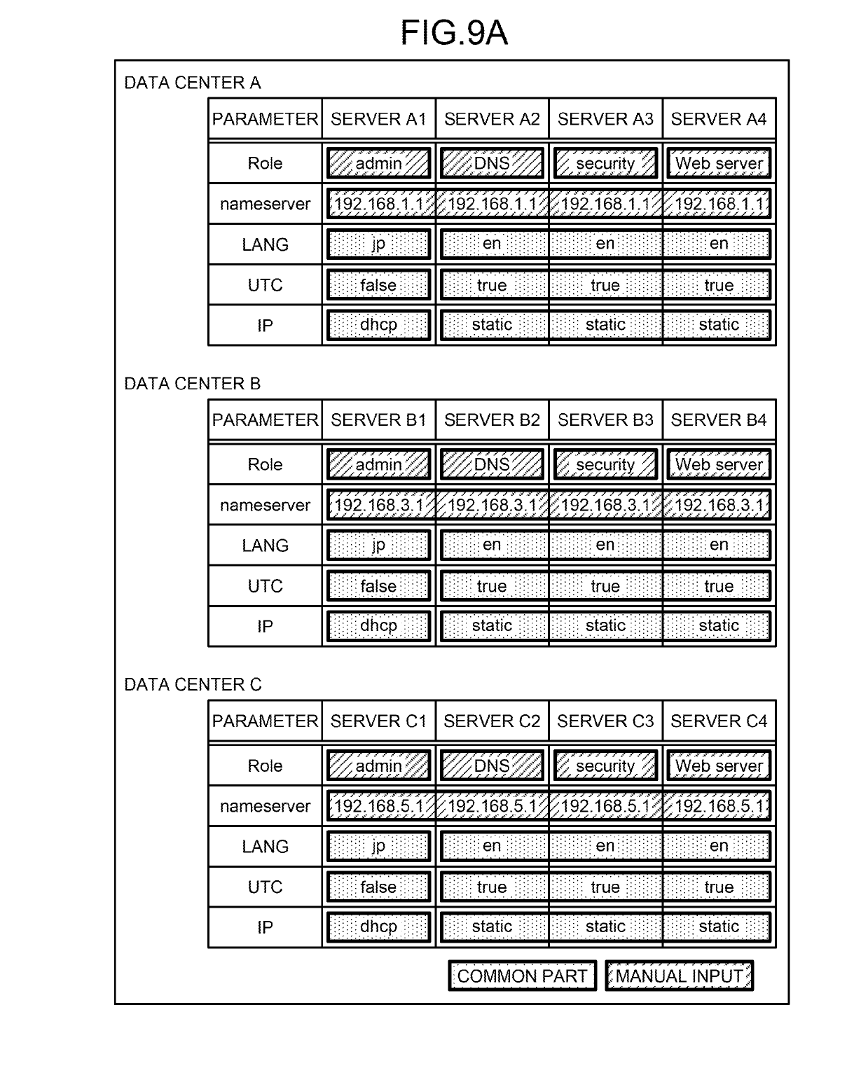

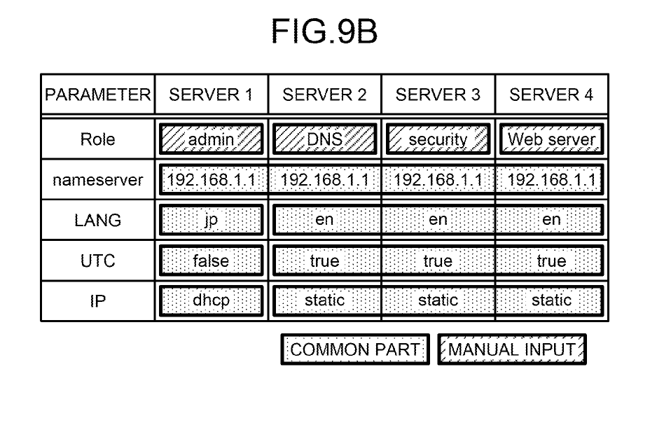

FIG. 9A is a diagram that illustrates the specific example of the operation performed by the parameter determining unit. As illustrated in FIG. 9A, the parameter determining unit 122 determines a manually input parameter among the parameters. Here, the parameter determining unit 122 determines that the parameter “Role”, which has the design rule “unique within a data center”, is a manually input parameter. This is because, if the design rule is “unique within a data center”, it is difficult for the parameter determining unit 122 to set the value by using the condition and the definition. Moreover, the parameter determining unit 122 determines that the parameter “nameserver”, which has the design rule “unique among data centers”, is a manually input parameter. This is because, if the design rule is “unique among data centers”, it is difficult for the parameter determining unit 122 to set the value by using the condition and the definition.

If a design unit is a server as a unit instead of a data center as a unit, a different parameter is determined to be a manually input parameter. FIG. 9B is a diagram that illustrates the specific example of the operation performed by the parameter determining unit when a design unit is a server as a unit. When a design unit is a server as a unit, the clustering unit 121 performs the clustering operation within a single data center. As illustrated in FIG. 9B, as “192.168.1.1” is set to all the servers with regard to the parameter “nameserver”, the clustering unit 121 identifies all the servers as the common part. Meanwhile, as the unique values, i.e., “admin”, “DNS”, “security”, and “Web server” are set to the parameter “Role” for the servers 1, 2, 3, and 4, the clustering unit 121 does not identify the common part. Specifically, the clustering unit 121 generates the design rule “unique among servers” with regard to “Role”. The parameter determining unit 122 determines that the parameter “Role”, which has the design rule “unique among servers”, is a manually input parameter. Thus, if a design unit is different, i.e., if it is a data center as a unit or a server as a unit, a different parameter is determined to be a manually input parameter.

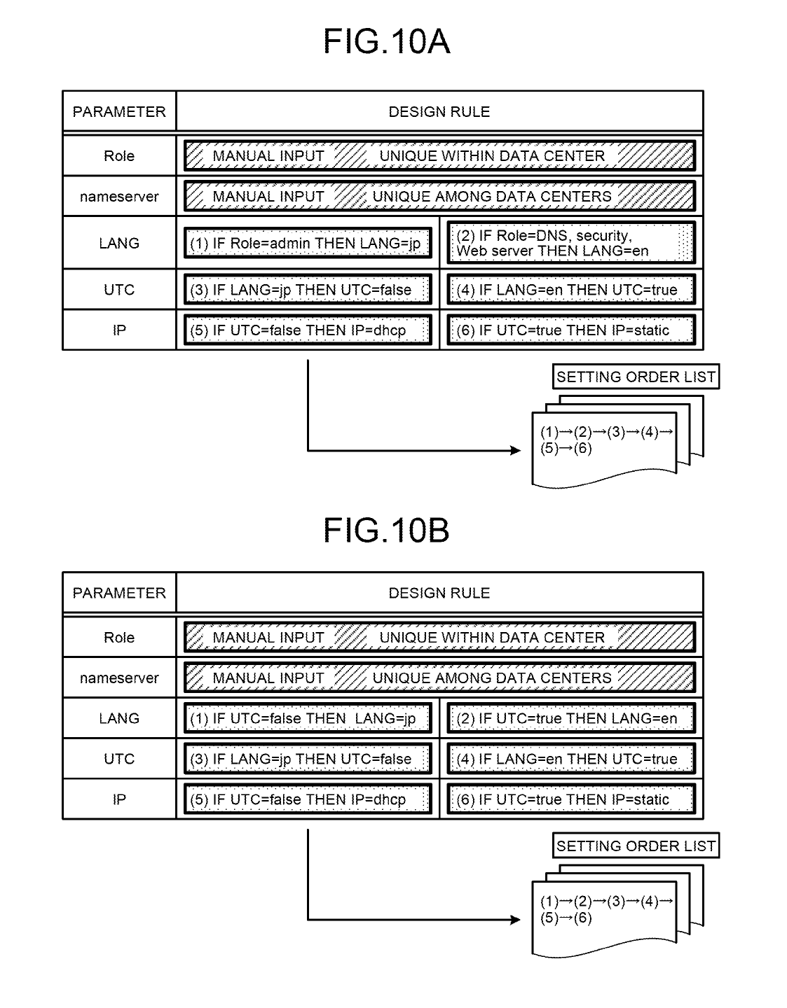

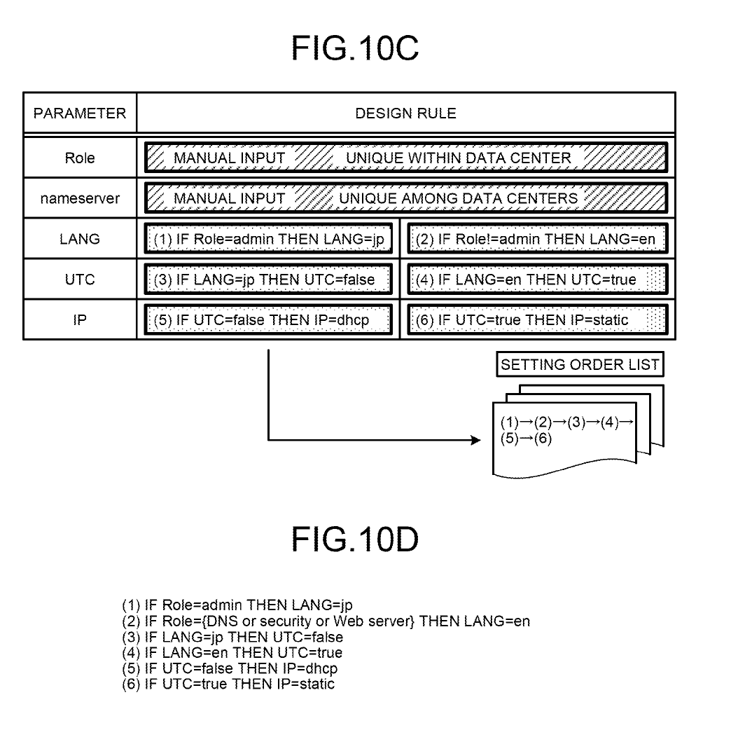

FIGS. 10A to 10D are diagrams that illustrate the specific example of the operation performed by the design-procedure generating unit. As illustrated in FIG. 10A, a design rule is defined for a corresponding parameter. Design rules are defined by the clustering unit 121 and the parameter determining unit 122. The manually input parameters are “Role” and “nameserver”.

The design-procedure generating unit 13 identifies the design rule whose condition is satisfied by the manual input and adds the identified design rule to the setting order list 22. Here, the design rules (1) and (2) of the parameter “LANG” are identified because the conditions of the design rules (1) and (2) are satisfied by the manually input parameter “Role” and the manually input value. The design rules (1) and (2) of the parameter “LANG” are added to the setting order list 22.

The design-procedure generating unit 13 then identifies the design rule whose condition is satisfied by the manual input and the definition of the previously identified design rule and adds the identified design rule to the setting order list 22. Here, the design rule (3) of the parameter “UTC” is identified because the condition of the design rule (3) is satisfied by the definition “LANG=jp” of the previously identified design rule (1). Similarly, the design rule (4) of the parameter “UTC” is identified because the condition of the design rule (4) is satisfied by the definition “LANG=jp” of the previously identified design rule (2). The design rules (3) and (4) of the parameter “UTC” are then added to the setting order list 22.

Furthermore, the design rule (5) of the parameter “IP” is identified because the condition of the design rule (5) is satisfied by the definition “UTC=false” of the previously identified design rule (3). Similarly, the design rule (6) of the parameter “IP” is identified because the condition of the design rule (6) is satisfied by the definition “UTC=true” of the previously identified design rule (4). The design rules (5) and (6) of the parameter “IP” are then added to the setting order list 22. Thus, the design-procedure generating unit 13 repeatedly performs the operation to generate the procedure in which the design rules are executed until there is no more design rules to be checked. As a result, the design-procedure generating unit 13 can add the design rules to the setting order list 22 in the following order: (1)→(2)→(3)→(4)→(5)→(6). Thus, the design-procedure generating unit 13 can generate the design procedure.

In some cases, however, it is difficult to identify a design rule whose condition is satisfied even if, for example, a parameter input is used. An explanation is given of such a case with reference to FIGS. 10B to 10D. As illustrated in FIG. 10B, a design rule is defined for a corresponding parameter. Design rules are defined by the clustering unit 121 and the parameter determining unit 122. The manually input parameters are “Role” and “nameserver”.

If there are design rules whose conditions are not satisfied by the manual input, the design-procedure generating unit 13 detects two design rules between which a circular reference is formed. Here, the definition “LANG=jp” of the design rule (1) refers to the condition of the design rule (3), and the definition “UTC=false” of the design rule (3) refers to the condition of the design rule (1); therefore, the design rules (1) and (3) are detected as the design rules between which a circular reference is formed.

Next, the design-procedure generating unit 13 eliminates, from the teaching data 21, any one of the parameters that are defined by the two circular-reference design rules and then causes the clustering unit 121 to perform the clustering operation again on the other one of the parameters. Here, the design-procedure generating unit 13 eliminates the parameter “UTC” that is defined by the design rule (3) among the two circular-reference design rules (1) and (3). The design-procedure generating unit 13 then causes the clustering unit 121 to perform the clustering operation again on the other one of the parameters, i.e., the parameter “LANG”.

As a result, a new design rule is generated by the clustering unit 121 with regard to the parameter “LANG”. As illustrated in FIG. 10C, the design rules (1) and (2) are generated with respect to the parameter “LANG”, the design rules (1) and (2) being not related to the circular-reference-related parameter “UTC”. The design-procedure generating unit 13 returns the eliminated parameter and then identifies the design rule whose condition is satisfied by the manual input and the definition of the previously identified design rule. The design-procedure generating unit 13 then adds the identified design rule to the setting order list 22. As a result, the design-procedure generating unit 13 can add the design rules to the setting order list 22 in the following order: (1)→(2)→(3)→(4)→(5)→(6). Thus, the design-procedure generating unit 13 can generate the design procedure. FIG. 10D illustrates the details of the design procedure stored in the setting order list 22.

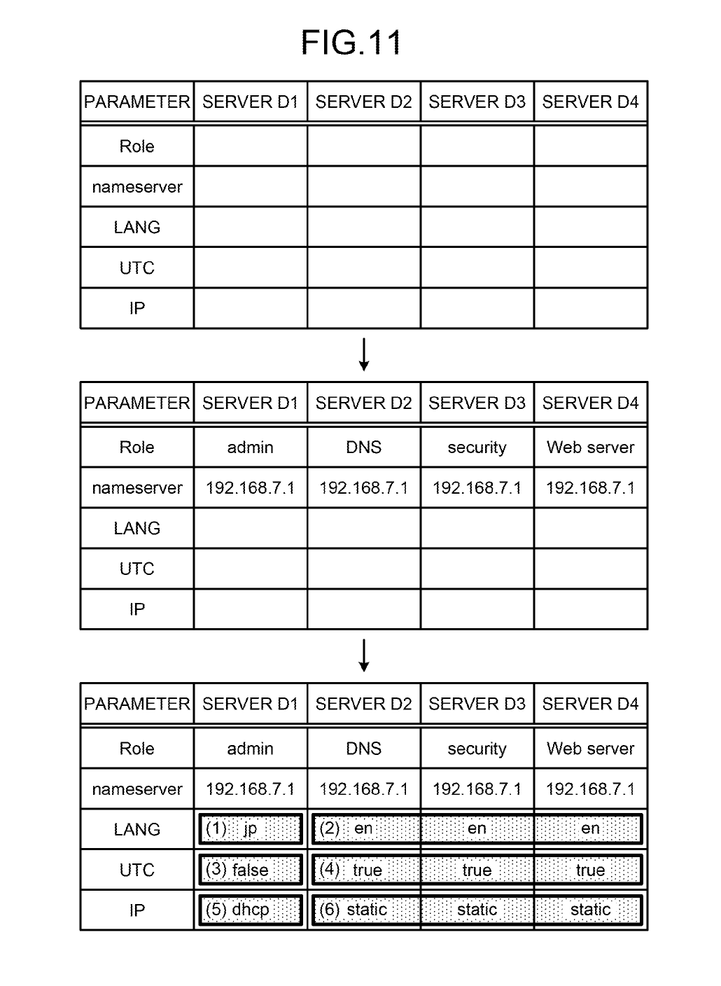

Next, an explanation is given, with reference to FIG. 11, of the operation performed by the parameter generating unit when a new data center D is added. FIG. 11 is a diagram that illustrates the specific example of the operation performed by the parameter generating unit when a new data center is added. The operation is performed by the parameter generating unit 14 by using the design procedure illustrated in FIG. 10D. The manually input parameters 23 are “Role” and “nameserver”.

As illustrated in the upper section of FIG. 11, the values of the parameters have not been generated yet for the servers D1 to D4 that are installed in the data center D.

As illustrated in the middle section of FIG. 11, when receiving the manual input with respect to the manually input parameters, the parameter generating unit 14 generates information on the manually input parameters. Here, the value “admin” input to the manually input parameter “Role” is assigned to the server D1. The value “DNS” input to the manually input parameter “Role” is assigned to the server D2. The value “security” input to the manually input parameter “Role” is assigned to the server D3. The value “Web server” input to the manually input parameter “Role” is assigned to the server D4. The value “192.168.7.1” input to the manually input parameter “nameserver” is assigned to the servers D1 to D4.

As illustrated in the lower section of FIG. 11, the parameter generating unit 14 sequentially generates information on the parameters in accordance with the design procedure. Here, “jp” is assigned to the parameter “LANG” of the server D1 in accordance with the design rule (1) of the design procedure illustrated in FIG. 10D. Furthermore, “en” is assigned to the parameter “LANG” of the servers D2 to D4 in accordance with the design rule (2) of the design procedure. Moreover, “false” is assigned to the parameter “UTC” of the server D1 in accordance with the design rule (3) of the design procedure. Further, “true” is assigned to the parameter “UTC” of the servers D2 to D4 in accordance with the design rule (4) of the design procedure. Moreover, “dhcp” is assigned to the parameter “IP” of the server D1 in accordance with the design rule (5) of the design procedure. Furthermore, “static” is assigned to the parameter “IP” of the servers D2 to D4 in accordance with the design rule (6) of the design procedure.

Thus, when the new data center D is added, the parameter generating unit 14 can generate the parameters in accordance with the design procedure and can set them in the target system 2.

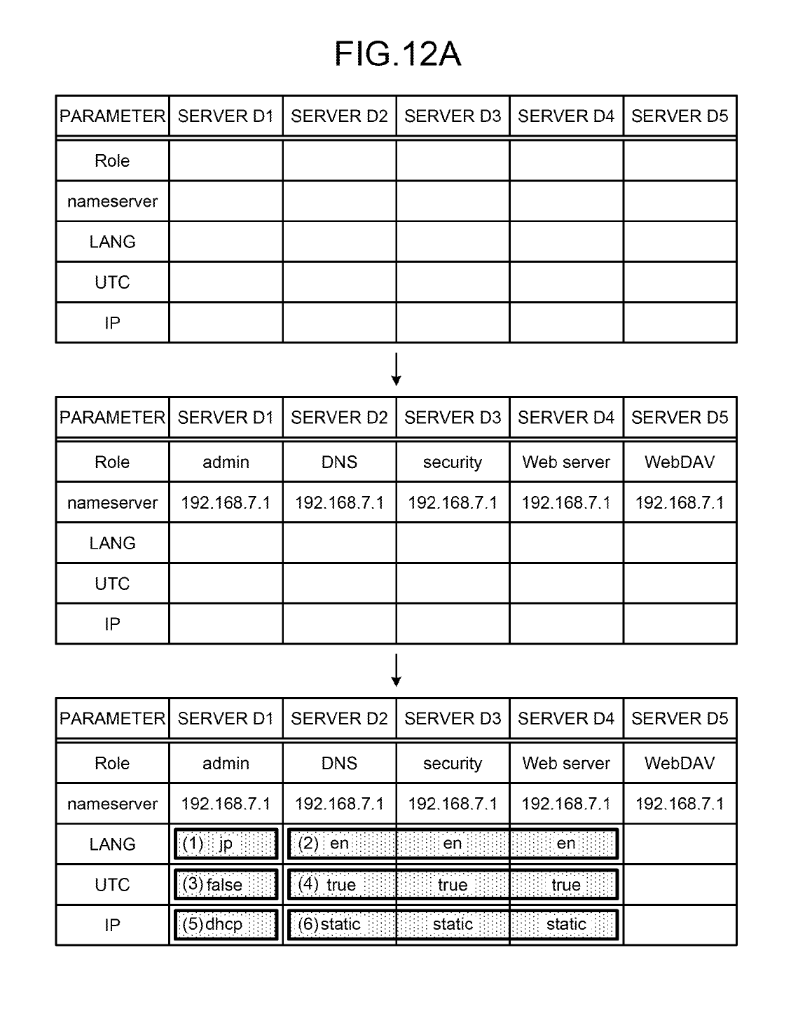

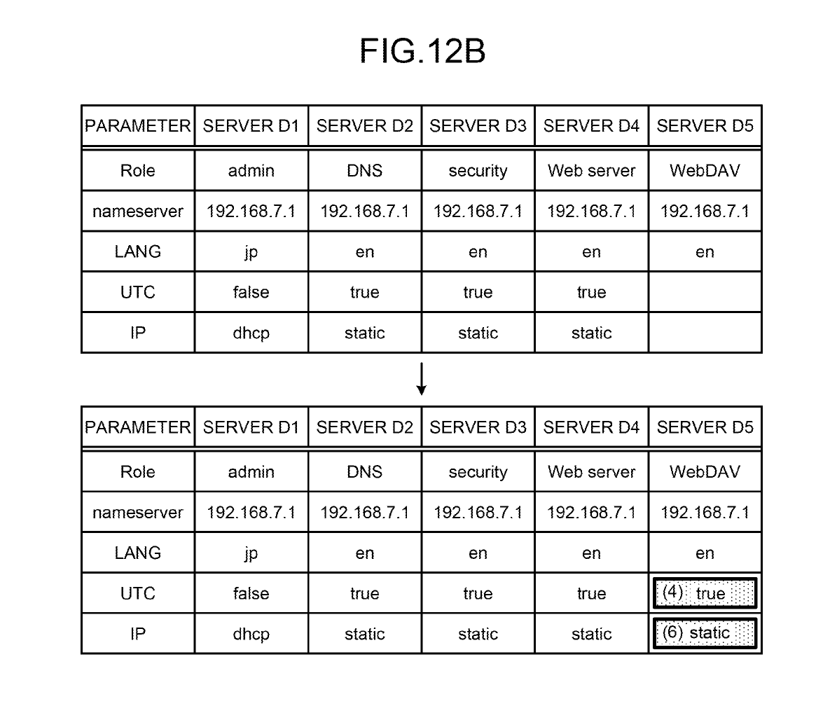

Next, an explanation is given, with reference to FIGS. 12A and 12B, of the operation performed by the parameter generating unit when a new server D5 is added to the data center D. FIGS. 12A and 12B are diagrams that illustrate the specific example of the operation performed by the parameter generating unit when a server is added. The operation is performed by the parameter generating unit by using the design procedure illustrated in FIG. 10D. The manually input parameters are “Role” and “nameserver”.

As illustrated in the upper section of FIG. 12A, the values of the parameters have not been generated yet for the servers D1 to D5 that are installed in the data center D.

As illustrated in the middle section of FIG. 12A, when receiving the manual input with respect to the manually input parameters, the parameter generating unit 14 generates information on the manually input parameters. Here, the operation performed on the servers D1 to D4 is the same as that explained with respect to the middle section of FIG. 11; therefore, its explanation is omitted. Then, the value “WebDAV” input to the manually input parameter “Role” is assigned to the new server D5. Furthermore, the value “192.168.7.1” input to the manually input parameter “nameserver” is assigned to the server D5.

As illustrated in the lower section of FIG. 12A, the parameter generating unit 14 sequentially generates information on the parameters in accordance with the design procedure illustrated in FIG. 10D. Here, the operation performed on the servers D1 to D4 is the same as that explained with respect to the lower section of FIG. 11; therefore, its explanation is omitted. Because there are no corresponding design rules in the design procedure with regard to the server D5, it is difficult for the parameter generating unit 14 to generate information on the parameters.

As illustrated in the upper section of FIG. 12B, if there are areas that have not been generated, the parameter generating unit 14 requests the administrator to make a manual input for the area corresponding to the parameter that comes first in the order among the areas that have not been generated. Here, the parameter “LANG” is the parameter that comes first in the order among the areas that have not been generated; therefore, as the result of the request made by the parameter generating unit 14, the input value “en” is assigned to the parameter “LANG”.

As illustrated in the lower section of FIG. 12B, the parameter generating unit 14 sequentially generates information on the parameters in accordance with the design procedure. Here, “true” is assigned to the parameter “UTC” of the server D5 in accordance with the design rule (4) of the design procedure illustrated in FIG. 10D. Furthermore, “static” is assigned to the parameter “IP” of the server D5 in accordance with the design rule (6) of the design procedure.

Thus, when the new server D5 is added to the data center D, the parameter generating unit 14 can generate the values of the parameters in accordance with the design procedure and can set them to the new server D5.

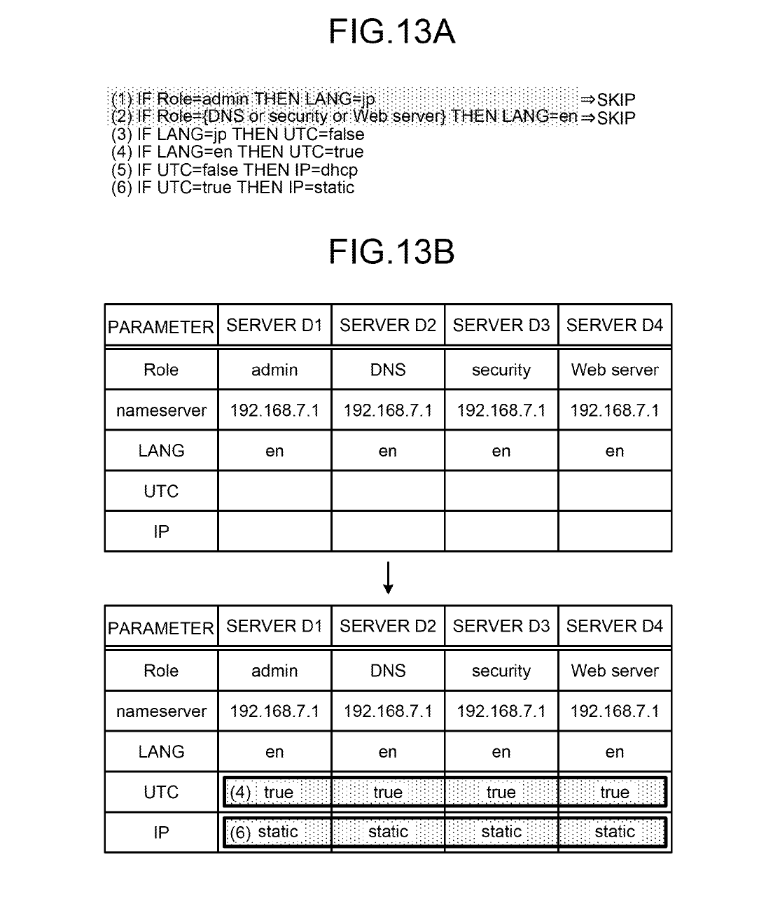

Next, an explanation is given, with reference to FIGS. 13A and 13B, of the operation performed by the parameter generating unit when the design principle of the data center D is changed. FIGS. 13A and 13B are diagrams that illustrate the specific example of the operation performed by the parameter generating unit when the design principle is changed. In this case, the design principle is changed such that the value “en” is set to the parameter “LANG” with respect to all the servers. Furthermore, the operation is performed by the parameter generating unit by using the design procedure illustrated in FIG. 10D. Moreover, the manually input parameters are “Role” and “nameserver”.

As illustrated in FIG. 13A, in order to make the parameter “LANG”, for which the design principle is changed, become a manually input parameter, the design rules (1) and (2) that define the value of the parameter “LANG” are skipped during the design procedure. For example, the administrator skips the design rules. That is, the design procedure from which the design rules (1) and (2) are removed is used.

As illustrated in the upper section of FIG. 13B, when receiving the manual inputs with respect to the manually input parameters, the parameter generating unit 14 generates information on the manually input parameters. Here, the operation performed on the servers D1 to D4 with respect to the manually input parameters “Role” and “nameserver” is the same as that explained with respect to the middle section of FIG. 11; therefore, its explanation is omitted. If there are areas that have not been generated, the parameter generating unit 14 requests the administrator to make a manual input for the area corresponding to the parameter that comes first in the order among the areas that have not been generated. Here, the design rules (1) and (2) that define the value of the parameter “LANG” are skipped during the design procedure; therefore, the parameter “LANG” is the parameter that comes first in the order among the areas that have not been generated. As the result of the request made by the parameter generating unit 14, the input value “en” is assigned to the parameter “LANG” for which the design principle is changed.

As illustrated in the lower section of FIG. 13B, the parameter generating unit 14 sequentially generates information on the parameters in accordance with the design procedure. Here, as the value “en” is set to the parameter “LANG” with respect to all the servers, “true” is assigned to the parameter “UTC” in accordance with the design rule (4) of the design procedure illustrated in FIG. 13A. Then, “static” is assigned to the parameter “IP” in accordance with the design rule (6) of the design procedure.

Thus, even if the design principle is changed, the parameter generating unit 14 can generate the values of the parameters in accordance with the design procedure and can set them to the target system 2 for which the design principle is changed.

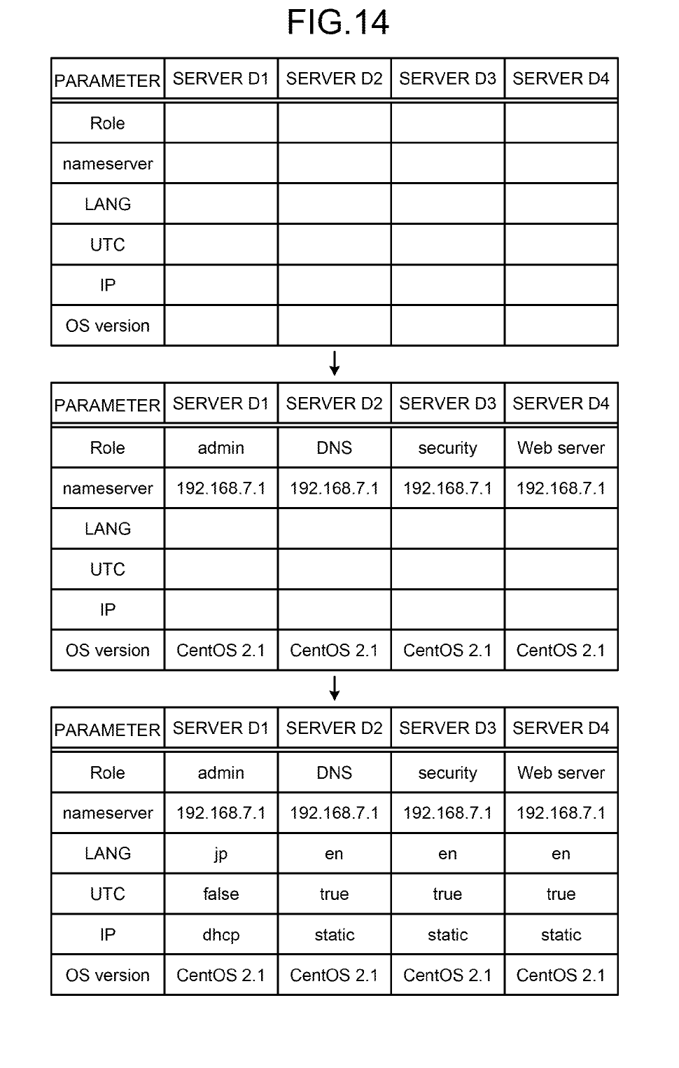

Next, an explanation is given, with reference to FIG. 14, of the operation performed by the parameter generating unit when a new parameter is added. FIG. 14 is a diagram that illustrates the specific example of the operation performed by the parameter generating unit when a new parameter is added. The operation is performed by the parameter generating unit by using the design procedure illustrated in FIG. 10D. The manually input parameters are “Role”, “nameserver”, and “OS version” that is a new parameter.

As illustrated in the upper section of FIG. 14, the values of the parameters have not been generated yet for the servers D1 to D4 that are installed in the data center D.

As illustrated in the middle section of FIG. 14, when receiving the manual inputs with respect to the manually input parameters, the parameter generating unit 14 generates information on the manually input parameters. Here, the operation performed on the servers D1 to D4 with respect to the manually input parameters “Role” and “nameserver” is the same as that explained with respect to the middle section of FIG. 11; therefore, its explanation is omitted. The value “CentOS 2.1” input to the new manually input parameter “OS version” is assigned to the servers D1 to D4.

As illustrated in the lower section of FIG. 14, the parameter generating unit 14 sequentially generates information on the parameters in accordance with the design procedure. Here, the values of the parameters “LANG”, “UTC”, and “IP” are generated in accordance with the design procedure with respect to the servers D1 to D4. As the operation performed on the servers D1 to D4 is the same as that explained with respect to the lower section of FIG. 11, its explanation is omitted.

Thus, even when a new parameter is added, the parameter generating unit 14 can generate the values of the parameters in accordance with the design procedure and can set the parameters including the new parameter to the target system 2.

Steps of Operation by Design-Rule Generating Unit

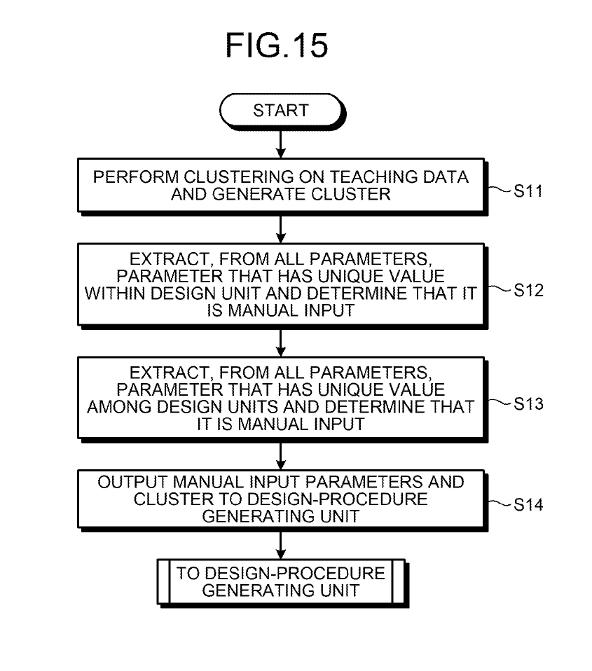

An explanation is given, with reference to FIG. 15, of the steps of the operation performed by the design-rule generating unit. FIG. 15 is a flowchart that illustrates the steps of the operation performed by the design-rule generating unit. The design-rule generating unit 12 receives a request for setting the parameters in the target system 2. Here, the target system 2 is a data center.

The clustering unit 121 of the design-rule generating unit 12 performs clustering on the teaching data 21 and generates a cluster (design rule) (Step S11). Specifically, the clustering unit 121 uses the clustering technique so as to identify, from the teaching data 21, the common part on the basis of a design unit, here a data center as a unit, and then generates a design rule from the clustering result.

The parameter determining unit 122 of the design-rule generating unit 12 extracts, from all the parameters included in the teaching data 21, the parameter that has a unique value within a design unit, here within a data center as a unit, and determines that it is a manual input (Step S12). The parameter determining unit 122 extracts, from all the parameters included in the teaching data 21, the parameter that has a unique value among the design units, here among the data centers as units, and determines that it is a manual input (Step S13).

The parameter determining unit 122 of the design-rule generating unit 12 then outputs the manually input parameters and the cluster (design rule) to the design-procedure generating unit 13 (Step S14).

Steps of Operation by the Design-Procedure Generating Unit

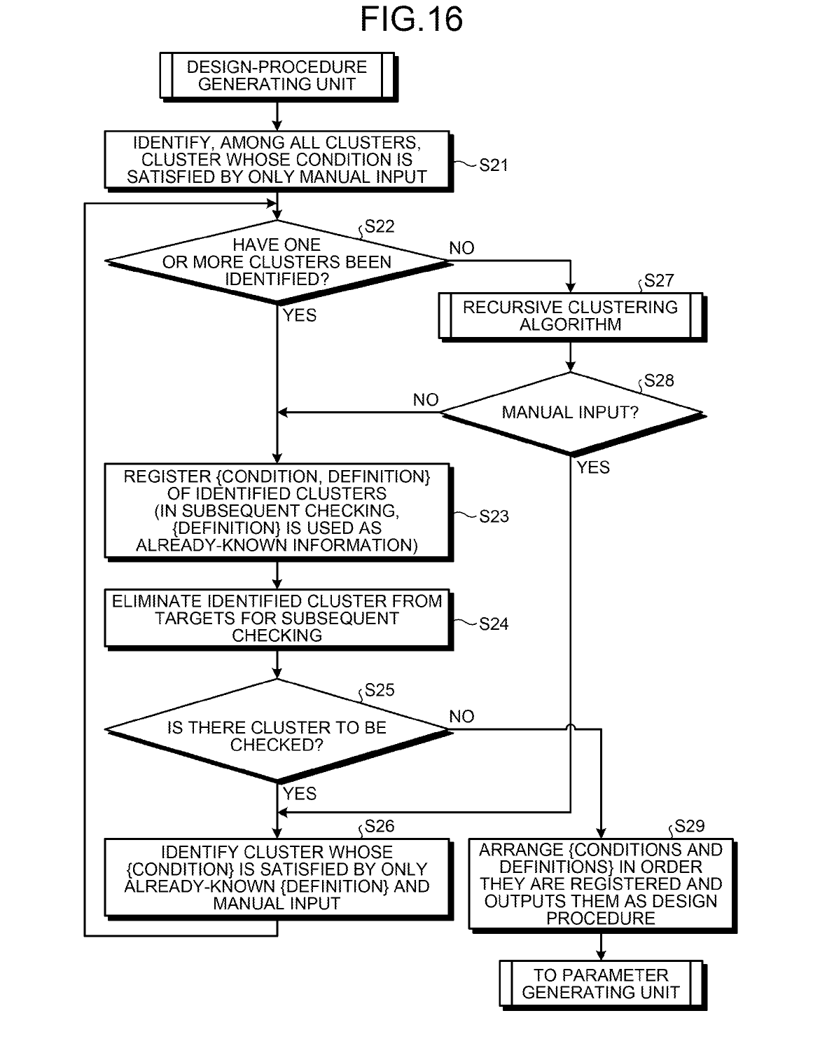

Next, an explanation is given, with reference to FIG. 16, of the steps of the operation performed by the design-procedure generating unit. FIG. 16 is a flowchart that illustrates the steps of the operation performed by the design-procedure generating unit. The manually input parameter and the clusters (design rules) have been received from the parameter determining unit 122.

The design-procedure generating unit 13 identifies, among all the clusters received from the parameter determining unit 122, the cluster (design rule) whose condition is satisfied by only the manual input (Step S21). The design-procedure generating unit 13 then determines whether it has identified one or more clusters whose conditions are satisfied (Step S22). If it is determined that one or more clusters whose conditions are satisfied have been identified (Step S22; Yes), the design-procedure generating unit 13 registers, in the setting order list 22, the conditions and definitions of the identified clusters (Step S23). In the subsequent checking, the design-procedure generating unit 13 uses the definition of the identified cluster as already-known information.

The design-procedure generating unit 13 then eliminates the identified cluster from the targets for the subsequent checking (Step S24). This is because, as the identified cluster has been registered in the setting order list 22, it has been already added to the order. The design-procedure generating unit 13 then determines whether there is a cluster to be checked (Step S25). If it is determined that there is a cluster to be checked (Step S25; Yes), the design-procedure generating unit 13 identifies the cluster whose condition is satisfied by only the already-known definition and the manual input (Step S26) and proceeds to Step S22.

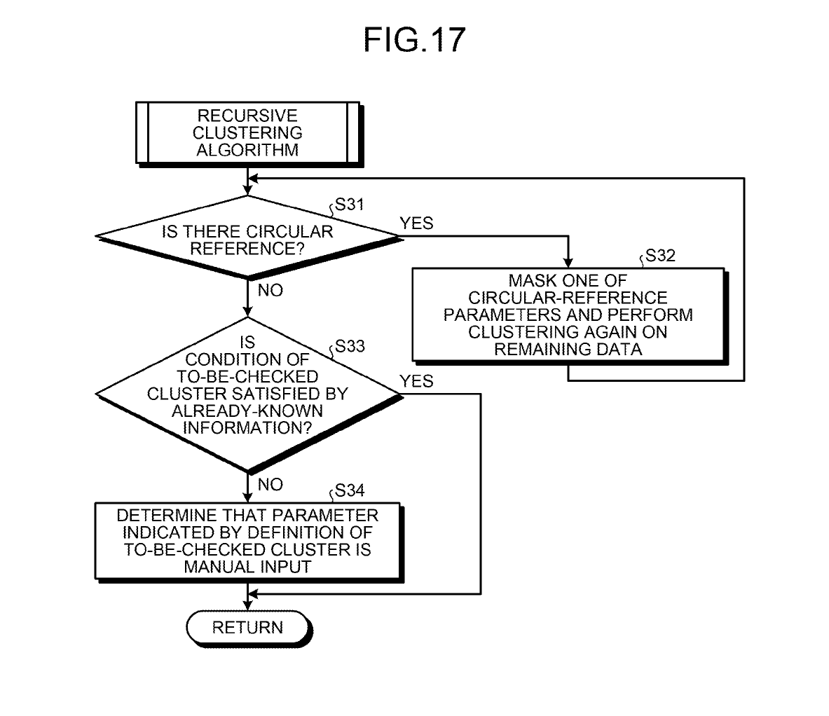

If it is determined at Step S22 that none of the clusters whose conditions are satisfied are identified (Step S22; No), the design-procedure generating unit 13 performs the recursive clustering algorithm (Step S27). In accordance with the result of the operation by the recursive clustering algorithm, the design-procedure generating unit 13 determines whether the to-be-checked cluster needs the manual input (Step S28). If it is determined that the cluster needs the manual input (Step S28; Yes), the design-procedure generating unit 13 proceeds to Step S26 so as to request the manual input for the cluster. Conversely, if it is determined that the cluster does not need the manual input (Step S28; No), the design-procedure generating unit 13 proceeds to Step S23 so as to register the cluster. The steps of the operation by the recursive clustering algorithm will be explained later with reference to FIG. 17.

If it is determined at Step S25 that there is no cluster to be checked (Step S25; No), the design-procedure generating unit 13 arranges the conditions and definitions of the clusters in the order they are registered in the setting order list 22 and then outputs them as the design procedure (Step S29). Subsequently, the process shifts to the design-procedure generating unit 13.

Steps of Operation by Recursive Clustering Algorithm

Next, an explanation is given, with reference to FIG. 17, of the steps of the operation by the recursive clustering algorithm that is illustrated at Step S27 of FIG. 16. FIG. 17 is a flowchart that illustrates the steps of the operation by the recursive clustering algorithm.

The design-procedure generating unit 13 determines whether there are circular-reference clusters among the to-be-checked clusters (design rules) (Step S31). For example, the design-procedure generating unit 13 extracts a set of clusters whose conditions are satisfied by one more. The design-procedure generating unit 13 then tries to detect, from the set of clusters, any two clusters whose definitions are included in each other's condition.

If it is determined that there are circular-reference clusters among the to-be-checked clusters (Step S31; Yes), the design-procedure generating unit 13 masks one of the circular-reference clusters and causes the clustering to be performed again on the remaining data (Step S32). For example, the design-procedure generating unit 13 eliminates, from the teaching data 21, any one of the parameters that are defined by the two circular-reference clusters. The design-procedure generating unit 13 then causes the clustering unit 121 to perform the clustering operation again on the other one of the parameters by using the parameters except for the eliminated parameter. The design-procedure generating unit 13 then proceeds to Step S31.

Conversely, if it is determined that there are no circular-reference clusters among the to-be-checked clusters (Step S31; No), the design-procedure generating unit 13 determines whether the condition of the to-be-checked cluster is satisfied by the already-known information (Step S33). Here, the already-known information means the definition of the already identified cluster, the manually input parameter, and its input value. If it is determined that the condition of the to-be-checked cluster is satisfied by the already-known information (Step S33; Yes), it is determined that the to-be-checked cluster does not need the manual input, and the process returns to the previous operation. Conversely, if it is determined that the condition of the to-be-checked cluster is not satisfied by the already-known information (Step S33; No), the design-procedure generating unit 13 determines that the parameter that is indicated by the definition of the to-be-checked cluster is a manual input (Step S34). That is, the design-procedure generating unit 13 determines that the to-be-checked cluster needs a manual input and then returns to the previous operation.

Steps of Operation by Parameter Generating Unit

Next, an explanation is given, with reference to

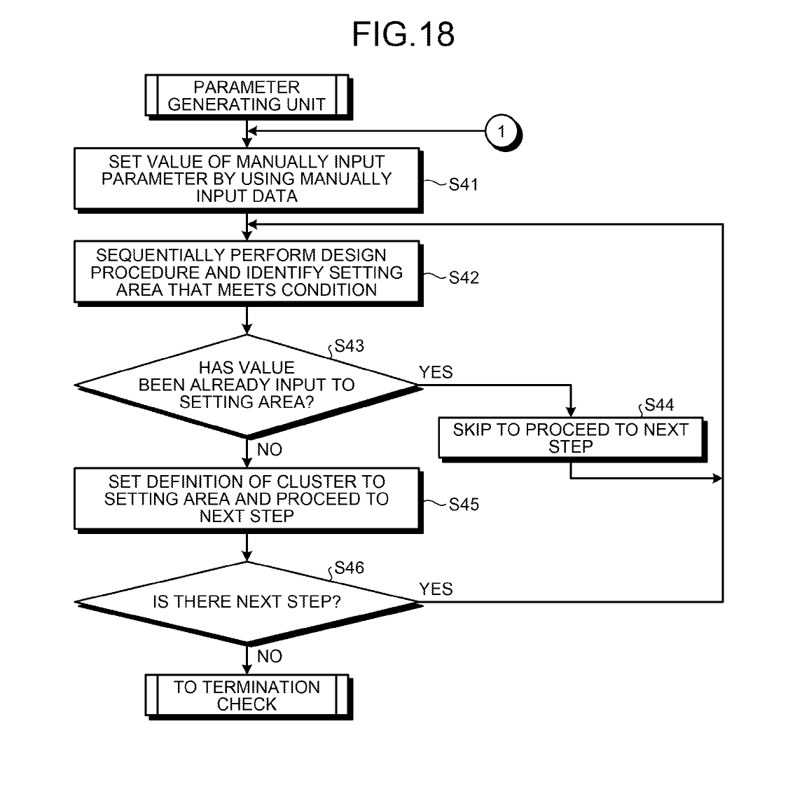

FIG. 18, of the steps of the operation performed by the parameter generating unit. FIG. 18 is a flowchart that illustrates the steps of the operation performed by the parameter generating unit. The manually input parameter 23 and the setting order list 22 have been generated.

The parameter generating unit 14 sets, by using manually input data, the value of the parameter that is stored as the manually input parameter 23 (Step S41). The parameter generating unit 14 then sequentially performs the design procedure stored in the setting order list 22 and identifies the setting area that meets the condition (Step S42).

The parameter generating unit 14 then determines whether the value has been already input to the identified setting area (Step S43). If it is determined that the value has been already input to the identified setting area (Step S43; Yes), the parameter generating unit 14 skips the identified setting area and proceeds to the next step (Step S44). The parameter generating unit 14 proceeds to Step S46.

Conversely, if it is determined that the value has not been input to the identified setting area yet (Step S43; No), the parameter generating unit 14 sets the definition of the cluster to the setting area and then proceeds to the next step (Step S45). The parameter generating unit 14 proceeds to Step S46.

At Step S46, the parameter generating unit 14 determines whether there is the next step (Step S46). If it is determined that there is the next step (Step S46; Yes), the parameter generating unit 14 proceeds to Step S42 so as to perform the operation at the next step. Conversely, if it is determined that there is not the next step (Step S46; No), the parameter generating unit 14 proceeds to a termination check.

Steps of Operation for Termination Check

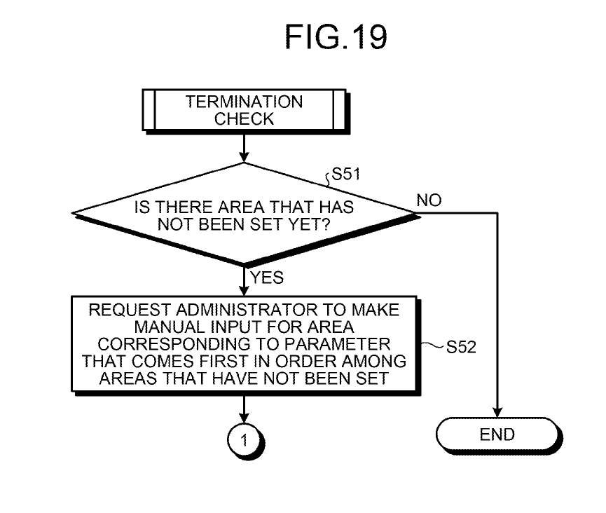

Next, an explanation is given, with reference to FIG. 19, of the steps of the operation for a termination check performed by the parameter generating unit 14. FIG. 19 is a flowchart that illustrates the steps of the operation for a termination check.

The parameter generating unit 14 determines whether there is an area that has not been set yet (Step S51). If it is determined that there is an area that has not been set yet (Step S51; Yes), the parameter generating unit 14 requests the administrator to make a manual input for the area corresponding to the parameter that comes first in the order among the areas that have not been set (Step S52). The parameter generating unit 14 then proceeds to Step S41.

Conversely, if it is determined that there is no area that has not been set yet (Step S51; No), the parameter generating unit 14 terminates the process.

### Advantages of Embodiment

According to the above-described embodiment, the parameter setting support device 1 stores, in the storage unit 11 and for each target system 2 that is the design target that has been previously designed, related information on multiple devices included in the target system 2 and information on the setting of the parameter used for designing. The parameter setting support device 1 then uses the related information stored in the storage unit 11 so as to generate, with respect to the parameter that is common to the target systems 2, multiple design rules that indicate the condition and definition used for the setting of the parameter. The parameter setting support device 1 then generates a design procedure to execute the generated design rules in accordance with the value of the manually input parameter and the design rules. With this configuration, the parameter setting support device 1 automatically generates the design rules and the design procedure; therefore, the appropriate value can be set to the parameter in the new target system 2 by using the generated design procedure. That is, the parameter setting support device 1 can automatically design the new target system 2.

Furthermore, according to the above-described embodiment, the parameter setting support device 1 identifies the design rule whose condition is satisfied by the manually input parameter and the value input to the parameter. The parameter setting support device 1 then generates a design procedure by using the identified design rule. The parameter setting support device 1 repeatedly identifies the design rule whose condition is satisfied by the definition of the identified design rule and then generates the design procedure by using the identified design rule. With this configuration, the parameter setting support device 1 repeatedly identifies the design rule whose condition is satisfied by the definition of the design rule, thereby easily generating the design procedure in which the design rules are executed.

Furthermore, according to the above-described embodiment, the parameter setting support device 1 extracts multiple design rules whose conditions are not satisfied by the manually input parameter, the value input to the parameter, and/or the definition of the identified design rule. The parameter setting support device 1 then detects any two design rules from the extracted design rules, the definitions of the design rules being included in each other's condition. The parameter setting support device 1 eliminates the parameter that is included in the definition of any one of the two detected design rules and then performs the operation to generate a design rule again on the parameter included in the definition of the other one of them. The parameter setting support device 1 then generates a design procedure by using the design rule that is obtained at the performing. With this configuration, even if there is a design rule whose condition is not satisfied, the parameter setting support device 1 eliminates the parameter that is included in the definition of any one of the design rules, the definitions of the design rules being included in each other's condition, and then re-generates a design rule with respect to the parameter that is included in the definition of the other one of them. As a result, the parameter setting support device 1 can generate a design procedure from the re-generated design rules.

Moreover, according to the above-described embodiment, the parameter setting support device 1 sets, by using the generated design procedure, the parameters used for designing the target system 2 that is a new design target. With this configuration, the parameter setting support device 1 can automatically set the parameters used for designing the target system 2 that is a new design target. As a result, the parameter setting support device 1 can reduce the workload of the system builder for designing the target system 2.

Others

The parameter setting support device 1 can be implemented by installing the functions of the above-described design-rule generating unit 12, the above-described design-procedure generating unit 13, and the like, in a known information processing apparatus, such as a personal computer or workstation.

Each component of the device illustrated does not necessarily need to be physically configured as illustrated in the drawings. Specifically, specific forms of separation and combination of the device are not limited to those depicted in the drawings. A configuration may be such that all or part of the device is functionally or physically separated or combined in an arbitrary unit depending on various types of loads or usage. For example, the clustering unit 121 and the parameter determining unit 122 may be combined as a single unit. Furthermore, the design-procedure generating unit 13 may be separated into a processing unit for a case where the condition is satisfied by the definition of the design rule and a processing unit for a case where the condition is not satisfied by the definition of the design rule. Moreover, the storage unit 11 may be stored in an external device of the parameter setting support device 1. The external device in which the storage unit 11 is stored may be connected to the parameter setting support device 1 via a network.

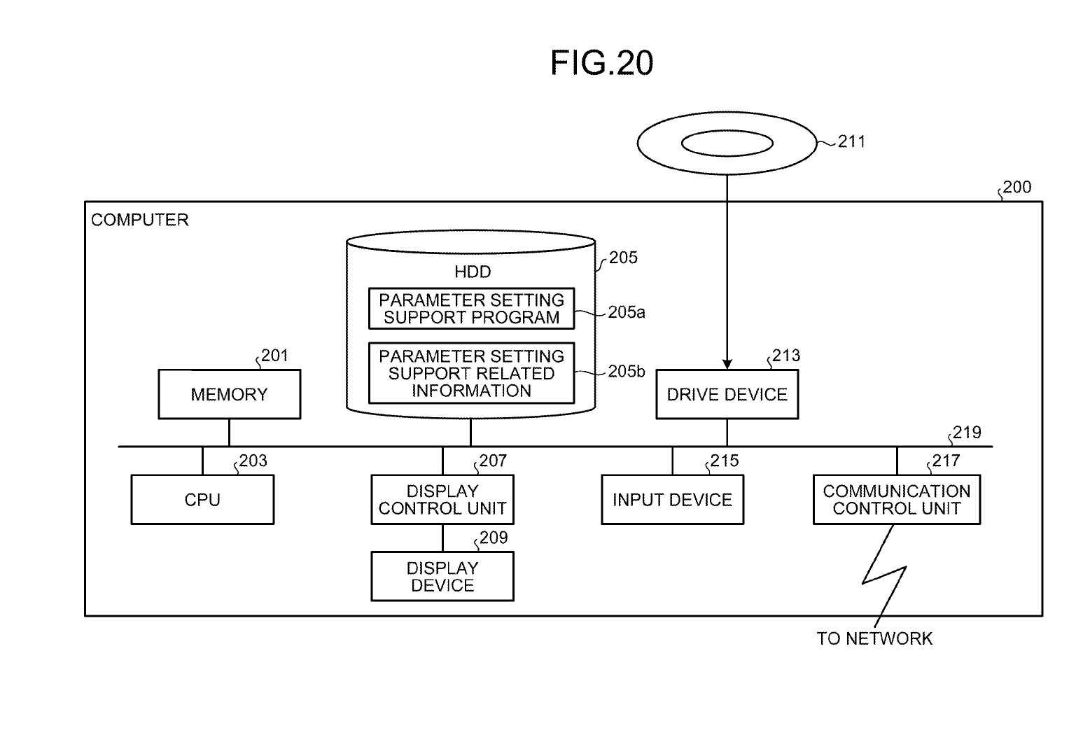

The various processes that have been described in the embodiment may be performed if prepared programs are performed by a computer, such as a personal computer or workstation. In the following, an explanation is given of an example of a computer that performs a parameter setting support program that performs the same functionality as that of the parameter setting support device 1 illustrated in FIG. 1. FIG. 20 is a diagram that illustrates an example of a computer that performs the parameter setting support program.

As illustrated in FIG. 20, a computer 200 includes a CPU 203 that performs various calculation operations; an input device 215 that receives an input of data from a user; and a display control unit 207 that controls a display device 209. Furthermore, the computer 200 includes a drive device 213 that reads a program, or the like, from a storage medium; and a communication control unit 217 that transmits and receives data to and from another computer via a network. Further, the computer 200 includes a memory 201 that temporarily stores therein various types of information; and an HDD 205. The memory 201, the CPU 203, the HDD 205, the display control unit 207, the drive device 213, the input device 215, and the communication control unit 217 are connected to one another via a bus 219.

The drive device 213 is, for example, a device for a removable disk 211. The HDD 205 stores therein a parameter setting support program 205a and parameter setting support related information 205b.

The CPU 203 reads the parameter setting support program 205a, loads it to the memory 201, and performs it as a process. This process corresponds to each functional unit of the parameter setting support device 1. The parameter setting support related information 205b corresponds to the teaching data 21, the setting order list 22, and the manually input parameters 23. For example, the removable disk 211 stores therein various types of information, such as the teaching data 21.

The parameter setting support program 205a does not always need to be initially stored in the HDD 205. For example, the parameter setting support program 205a is stored in a “portable physical medium”, such as a flexible disk (FD), CD-ROM, DVD disk, magnet-optical disk, or IC card, which is inserted into the computer 200. The computer 200 reads the parameter setting support program 205a from the above and executes it.

According to an aspect of the parameter setting support program disclosed in the present application, it is possible to automatically design the system.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein a parameter setting support program for causing a computer to execute a process comprising:
storing in a storage unit, for each design target that has been previously designed, related information on a plurality of devices included in a design target and information on a setting of a parameter that has been used for designing;
generating, by using the related information stored in the storage unit, multiple rules with respect to a parameter that is common to the design targets, the rules indicating conditions and definitions that are used for a setting of the parameter; and
generating a procedure to execute the rules in accordance with a manually input value of a parameter and the generated rules.

2. The non-transitory computer-readable recording medium according to claim 1, wherein the generating the procedure includes generating the procedure by repeatedly performing a process to identify the rule whose condition is satisfied by a manually input value of a parameter, to generate the procedure by using the identified rule, to identify the rule whose condition is satisfied by a definition of the identified rule, and to generate the procedure by using the identified rule.

3. The non-transitory computer-readable recording medium according to claim 2, wherein the generating the procedure includes extracting multiple rules whose conditions are not satisfied by a manually input value of a parameter and a definition of an identified rule, detecting any two rules from the extracted rules, each definition of the rules being included in each other's condition, eliminating a parameter that is related to a definition of any one of the two detected rules, performing the process to generate the rule again on a parameter related to a definition of other one of the rules, and generating the procedure by using the rule obtained at the performing.

4. The non-transitory computer-readable recording medium according to claim 3, the process further including,
setting a parameter that is used for designing a new design target by using the procedure generated at the generating.

5. A parameter setting support device comprising:
a processor; and
a storage unit that stores, for each design target that has been previously designed, related information on a plurality of devices included in a design target and information on a setting of a parameter that has been used for designing, wherein the processor executes:
generating, by using the related information stored in the storage unit, multiple rules with respect to a parameter that is common to the design targets, the rules indicating conditions and definitions that are used for a setting of the parameter; and
generating a procedure to execute the rules in accordance with a manually input value of a parameter and the generated rules.

6. A method for supporting parameter setting, the method comprising:
storing, in a storage unit and for each design target that has been previously designed, related information on a plurality of devices included in a design target and information on a setting of a parameter that has been used for designing;
generating, by using the related information stored in the storage unit, multiple rules with respect to a parameter that is common to the design targets, the rules indicating conditions and definitions that are used for a setting of the parameter using a processor; and
generating a procedure to execute the rules in accordance with a manually input value of a parameter and the generated rules using the processor.
